(19) United States
(12) Patent Application Publication
(10) Pub. No.: US 2022/0148396 A1
(43) Pub. Date: May 12, 2022

(54) SYSTEM AND METHOD OF A CONCEALED THREAT DETECTION SYSTEM IN OBJECTS

(71) Applicant: PatriotOne Technologies, Toronto (CA)

(72) Inventors: Munir TARAR, Toronto (CA); Nevine DEMITRI, Toronto (CA); Paul RICE, Formby (GB); Phil LANCASTER, Toronto (CA); Dietmar WENNEMAR, Toronto (CA); Shawn Kevin GRIFFIN, Toronto (CA)

(73) Assignee: PatriotOne Technologies, Toronto (CA)

(21) Appl. No.: 17/523,171

(22) Filed: Nov. 10, 2021

Related U.S. Application Data
(60) Provisional application No. 63/111,815, filed on Nov. 10, 2020.

(51) Int. Cl. G08B 13/196; G01V 3/10; G08B 13/24

(52) U.S. Cl. CPC G08B 13/19619; G08B 13/24; G01V 3/10

(57) ABSTRACT

A system and method for concealing a threat detection system in planter boxes. Hiding the threat detection systems in planters provides a covert way of weapon detection. The planters are aesthetically pleasing and do not interfere visually with the environment in which they are deployed. This provides a commercial advantage for clients specifically in casinos, hotels, stadiums, where the visual environment is of importance. A system and method for visual threat confirmation or rejection using object recognition when the location of a threat and the possibility of a threat have been identified by other means.

### CROSS REFERENCE TO RELATED APPLICATIONS

The application claims priority to and the benefit of U.S. Provisional Patent Application Ser. No. 63/111,815, entitled “THREAT DETECTION SYSTEM CONCEALED INSIDE PLANTER BOXES”, filed on Nov. 10, 2020, the disclosure of which is incorporated herein by reference in its entirety.

### BACKGROUND

The embodiments described herein relate to security and surveillance, in particular, technologies related to video recognition threat detection.

Security screening and/or threat detection systems are installed in offices, airports and buildings to screen for potential threats (i.e., knives, guns, weapons, etc.). One concern is how to place or conceal the threat detection systems in inconspicuous objects (e.g., planter boxes) where the detection system is not as obvious and fits in with the environment.

Further, magnetic based threat detection systems have problems discriminating between threats and benign objects because of similar metal content. An example is distinguishing between a Glock gun and an iPhone 8 cell phone. Varying the sensitivity threshold can create either a large number of false positives that require secondary screening with resulting increased cost, or failing to detect a threat.

There is a desire to implement a system and method concealing a threat detection system in inconspicuous objects such as planter boxes. There is also a desire to provide a system and method for visual threat confirmation.

### SUMMARY

A system and method for concealing a threat detection system in planter boxes. Hiding the threat detection systems in planters provides covert weapon detection. The planters are aesthetically pleasing and do not interfere visually with the environment in which they are deployed. This provides a commercial advantage for clients particularly in casinos, hotels, stadiums, where the visual environment is of importance.

A system and method for visual threat confirmation or rejection using object recognition when the location of a threat and the possibility of a threat have been identified by other means. Other methods exist that use magnetic properties of objects to determine if it is a possible threat and also using the same properties to locate the object in a plane.

### BRIEF DESCRIPTION OF THE DRAWINGS

FIGS. 1A-1C are diagrams illustrating an exemplary threat detection system deployed in planter boxes.

FIG. 2 is a block diagram illustrating an exemplary planter box threat detection system.

FIG. 3A is a diagram illustrating a bollard planter box threat detection system.

FIG. 3B is a diagram illustrating further embodiments of bollard threat detection system.

FIG. 4 is a diagram illustrating use case of planter box threat detection system.

FIG. 5 is a diagram illustrating use case of Visual Threat Confirmation using a planter box threat detection system.

### DETAILED DESCRIPTION

In a preferred embodiment, a threat detection device is placed inside a pair of planter boxes. Both plastic plants or real plants can be placed on the planter boxes. If real plants are placed a drain can be included to drain the water away from the electronics. Tests are performed to ensure that the water flow and water content in the plant soil does not interfere with the signals.

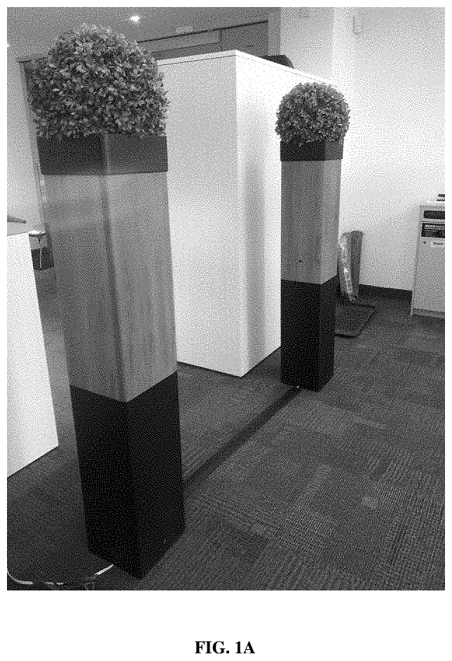

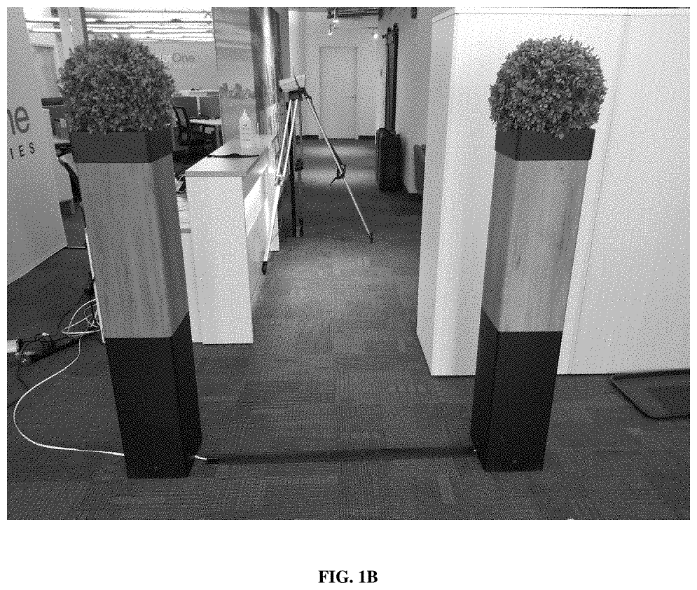

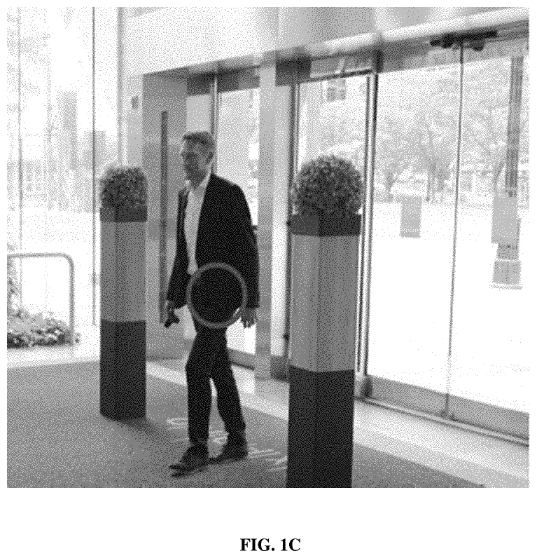

FIGS. 1A-1C are diagrams illustrating an exemplary threat detection system deployed in planter boxes. FIGS. 1A-1B illustrated an exemplary threat detection system deployed in planter boxes. According to these figures, the planter boxes are deployed at the entrance to an office. A pair of planter box columns are placed sufficiently far apart (i.e., 2 meters).

Decorative plants, either fake or real, are placed on the planter boxes. The planter boxes or planter box columns are connected via concealed wires where a cover is placed on top. The concealed wires provide power and Ethernet connection between both columns. In further embodiments, the concealed wires can be replaced with a wireless connection or another type of data connection. The planter box columns contain sensors to implement a threat detection system. At least one of the columns will also have a power cord and/or connection to the internet.

FIG. 1C is a diagram of an exemplary threat detection system deployed in planter boxes in a front entrance of a building. As seen in FIG. 1C, two planter box columns are placed by the front door in a building. A person can be seen entering the building, walking through these planter box columns.

A threat detection system using a multi-sensor gateway (MSG), such as the Patriot One PATSCAN MSG offers detection of concealed weapons on people and in bags using artificial intelligence (AI) and/or machine learning (ML) coupled with magnetic moment techniques. The multi-sensor gateway (MSG) allows for the discovery of a “weapon signature” (i.e., object shape such as handguns, rifles, knives or bombs). Its configuration can detect and identify where on the individual's body or bag the metal threat object resides.

As seen in FIG. 1C, the MSG threat detection system can detect a concealed object (i.e., round circle in image) and may infer that this can be a weapon threat. This information is sent to a central processor and is provided to an operator, security officers or to police enforcement. Further, the MSG threat detection system may be connected to an alert system where lights and sounds can be triggered once a threat is detected.

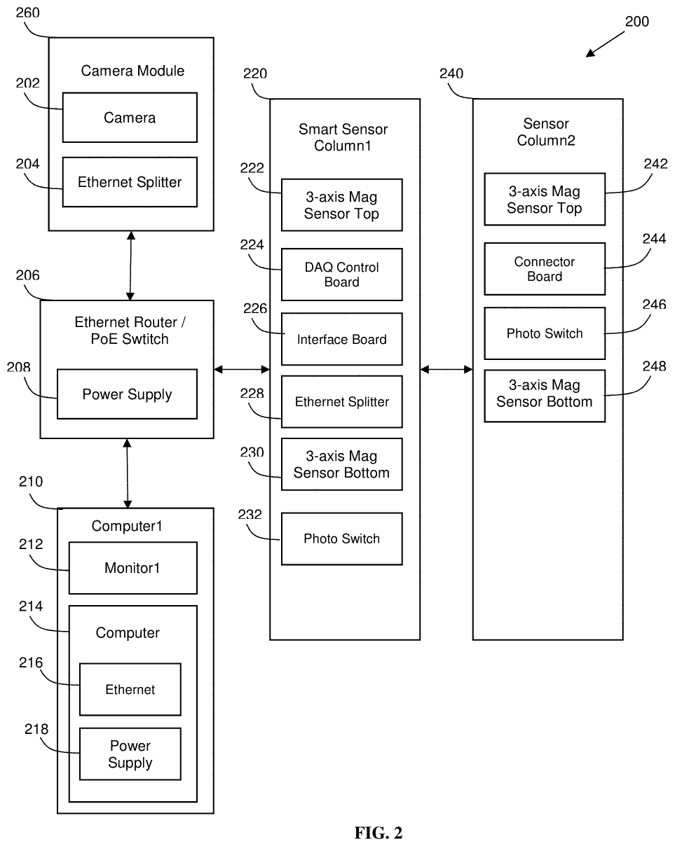

FIG. 2 is a block diagram illustrating an exemplary planter box threat detection system. According to FIG. 2, the threat detection system 200 consists of a first sensor column 220 (i.e., smart column) includes a photoelectric sensor 232 (e.g., photo switch), a power supply 232, a computer control board 224 (e.g., a LabJack DAQ board), an interface board 226, a plurality of 3-axis magnetic sensors 222, 230. Connection interfaces for ethernet router 206, ethernet splitter 204, 228 and ethernet PoE (power of Ethernet) is also provided. Photoelectric sensor 232 may also include a photo emitter.

While Ethernet, and in particular powered Ethernet provides many advantages in reliably connecting the columns to the data analysis computer, several other power and connectivity options are available that would have a different set of advantages, for example connections to route the data could be WiFi® connections, BlueTooth® connections, short range wireless, WAN or cellular connections. In addition, power can be supplied to the columns via several means, including direct AC power connections, PoE, 12V DC connections, or battery connections. In future embodiments, first sensor column 220 may incorporate a computer processor.

The threat detection system 200 also consists of a second sensor column 240 comprising a second photoelectric sensor 246 (e.g., photo switch), a connector board 244 and a plurality of 3-axis magnetic sensors 242 and 248. A plurality of wires is provided to connect the interface board 226 of the first column 220 with the connector board 244 of the second column 240. Photoelectric sensors or photo switches 246, 232 are optical sensors that detects motion when people pass through. In further embodiments, sensor columns 220, 240 may include dedicated power supplies.

Attached to the first smart sensor column 220 includes an ethernet router and PoE (Power over Ethernet) switch 206, which can be connected to a 48V power supply 208, a computer system 210 and a camera module 260. The computer system 210 consists of monitor 212 and computer 214 which may be a laptop or small size computer unit. Computer 214 further comprises a computer processor (not shown), power supply 218 and ethernet connection 216. Camera module 260 consists of one or more camera 202 and ethernet splitter 204.

In further embodiments, the computer 210, 214 may be replaced by a processor housed within the sensor columns 220, 240. In further embodiments, the ethernet connection of threat detection system 200 may be replaced with a Bluetooth®, cellular or WiFI® wireless connection, thus removing the need for running ethernet cables.

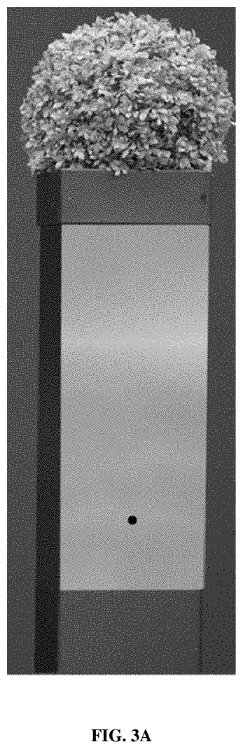

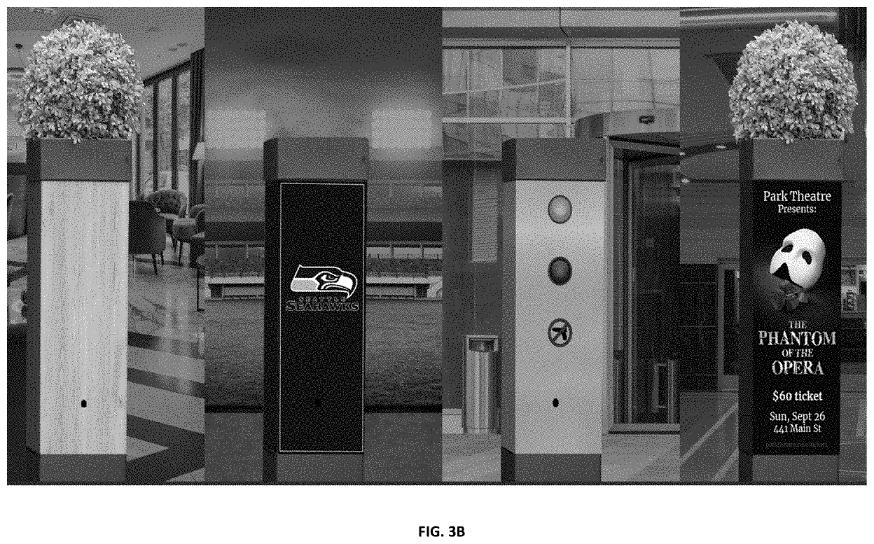

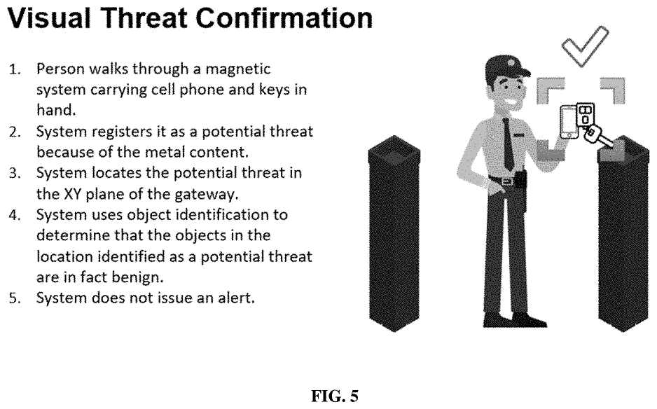

FIG. 3A is a diagram illustrating a bollard planter box threat detection system. According to FIG. 5A, a bollard (sturdy, short, vertical post) Is disclosed with a planter box on top. The plant in the planter box may be real or artificial. The threat detection system can be contained in one bollard post or multiple posts with circuitry for multiple columns. The bollard post may be wrapped in an outer layer or skin that can display advertisements or additional information. The skin may display static content, or may be an active programmable display that indicates dynamic information.

FIG. 3B is a diagram illustrating further embodiments of bollard threat detection system. According to FIG. 3B, different bollard designs are shown. These bollards contain the threat detection system, either as a single unit or working across multiple bollards. Furthermore, these bollards can be used to show advertisement material and designs, as well as, serving as planter boxes. According to FIG. 5B, such signage or designs as a marble planter box, a Seattle Seahawks signage, no weapons poster and a Phantom of the Opera signage are disclosed.

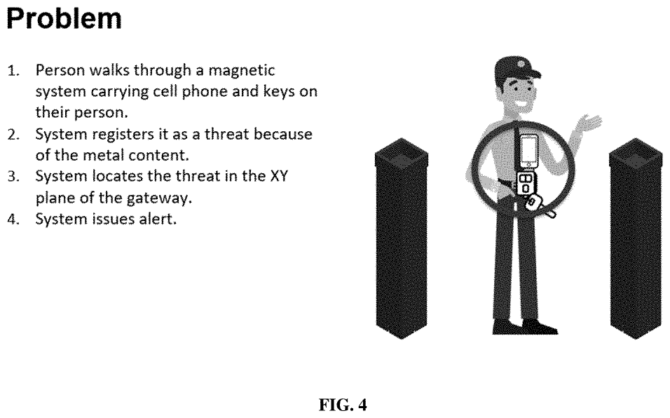

FIG. 4 is a diagram illustrating use case of planter box threat detection system. Often when a detector determines there is a threat, the sensitivity of the detector may not be able to discriminate between objects with similar properties, such as a handgun vs a metal coffee mug or an item with a magnetic clasp. When the detector can determine the location of the threat in a plane, the innovation proposes using object recognition to determine if the object is truly a threat.

As seen in FIG. 4, a use case or sequence of event may be as follows:
1. A person walks through a gateway.
2. The gateway determines that there is a potential threat on the person, and the location of that object within the plane of the gateway.
3. A camera focused on the gateway takes a picture of the person at the instant they are passing through the gateway.
4. Using that information, the innovation uses object recognition on the location of the threat object to determine if the object is actually a threat.
   a. If there is a threat, or if the object cannot be determined to not be a threat, the threat is alerted.
   b. If the object has been deemed to not be a threat, the alert is not raised.

FIG. 5 is a diagram illustrating use case of Visual Threat Confirmation using a planter box threat detection system. As seen in FIG. 5, Visual Threat Confirmation consists of:
1. A person walks through a magnetic system carrying cell phone and keys in hand.
2. The system registers it as a potential threat because of the metal content.
3. The system locates the potential threat in the XY plane of the gateway.
4. The system uses object identification to determine that the objects in the location identified as a potential threat are in fact benign.
5. The system does not issue an alert.

Some further features of the threat detection system include:
Using other technologies such as magnetic detectors to detect the presence of a threat object.
Using other technologies such as magnetic detectors to detect the location of the object in the plane of the detector as the person walks through.
Using object identification ONLY on the location of the potential threat object. If a person is holding a metal travel mug, it can be identified and classed as benign.
If the object is not identified, it can be classified as a threat.
If there are multiple objects, the location of the threat will not locate on a single object, so the threat will not be classified as benign.

In further embodiment, other use cases for a threat detection system consists of the following:
1. Fastlane where there are problematic objects such as an Apple Airpods® cases with magnets, metal travel mugs, etc.
   a. People can be instructed to take problematic objects out of their pockets and hold them in their hand out to the side.
   b. When the person goes through the gateway, the gateway determines that it is a possible threat.
   c. The location of the potential threat object is determined within the plane of the gateway.
   d. A camera that is focused on the gateway takes a picture when the threat is detected. Multiple cameras may be used to improve the accuracy of the visual detection.
   e. Using the location of the object and object identification, the detector can determine that it is NOT a threat, even if the object is not recognized.
   f. If the person is carrying a threat hidden on their person, the location of the object will not be on the hand of the person, and the object identification will fail.
2. Fastlane where there are objects like stretchers and hospital equipment.
   a. When a large metal object goes through like a stretcher, the attendant is instructed to walk beside the stretcher.
   b. The system detects a threat, and locates the threat in the plane.
   c. Object identification locates the object. Because the system has determined that the threat object is solely on the stretcher, the alert can be cancelled.
   d. If the attendant was carrying a weapon the location of the threat object would be pulled off the stretcher, the system would issue an alert.

Today people will have to divest themselves of metal objects or they go through a secondary screening. One unique feature of this disclosure is that it combines the location of the threat object with object identification in a way that has not been done before.

According to this disclosure, an additional feature is the detection of a possible threat and the location of the detected threat in a plane from a magnetic detector. These are two pieces of information that are widely available today. We then use object identification from a camera to determine that it is not a threat. This gives us the advantage of a significant decrease in false positives, with a corresponding decrease in operational costs and increase in throughput.

A competitor using this method would have to outline it in their documentation. It requires letting security personnel know why a potential threat was cleared. It is possible to use other sensors such as x-ray, electromagnetic pulse, passive magnetic field disturbance detection, thermal, chemical detectors, or RF interference instead of or in addition to an optical camera to clear the threat object.

Disclosed herein is system for providing a concealed threat detection system. The threat detection system comprises a first smart sensor column having a photoelectric sensor, a second sensor column having a second photoelectric sensor, a computer system, an ethernet router and a camera module. The photoelectric sensors of the first smart sensor column and second sensor column detects an interruption and the sensor columns, computer system, camera module and Ethernet router are connected by ethernet connection.

The threat detection system further comprising sensor elements chosen from a list consisting of magnetic sensors, x-ray detectors, electromagnetic pulse, chemical detectors, passive magnetic field disturbance detection, thermal sensors, and RF interference sensors. The threat detection system further contains at least one of a control board, interface board, Ethernet splitter, power supply and photo switch. The camera module of the threat detection system further comprises one or more cameras.

The threat detection system further comprises wireless connectivity including Bluetooth®, cellular connection or WiFi®. The threat detection system is concealed as a planter box or bollard, preferably with a plant on top. Furthermore, the threat detection system is be wrapped with signage or advertisement.

Disclosed herein is a further threat detection system comprising at least one sensor column having a multi axis magnetic sensor, a data router and a camera module. The threat detection system is capable of detecting potential threats by analyzing data from the multi axis magnetic sensor, determining whether the potential threat is similar to a previously known threat, determining whether a visual image of the area is captured coinciding with the time of the threat detection, refraining from outputting an alert if the visual image contains a benign object with a similar signature to the determined threat and outputting an alert if the visual image contains a positive object match with a similar signature to the determined threat. This threat detection system is concealed as a planter box or bollard, preferably with a plant on top and is wrapped with signage or advertisement.

Disclosed herein is a further method of improving the accuracy of a threat detection system. The method comprised the steps of detecting a potential threat by analyzing data from multi axis sensors, determining whether the potential threat is similar to a previously known threat, capturing a visual image of the area coinciding with the time of the threat detection, providing logic in the threat detector system to refrain from outputting an alert if the visual image contains a benign object with a similar signature to the determined threat and providing logic in the threat detector system to output an alert if the visual image contains a positive object match with a similar signature to the determined threat. The aforementioned threat detection system is concealed as a planter box or bollard, preferably with a plant on top and is wrapped with signage or advertisement.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A system for providing a concealed threat detection system comprising:
a first smart sensor column having a photoelectric sensor;
a second sensor column having a second photoelectric sensor;
a computer system;
an ethernet router; and
a camera module;
wherein the photoelectric sensors of the first smart sensor column and second sensor column detects an interruption; and
wherein the sensor columns, computer system, camera module and Ethernet router are connected by ethernet connection.

2. The system of claim 1 further comprising sensor elements chosen from a list consisting of magnetic sensors, x-ray detectors, electromagnetic pulse, chemical detectors, passive magnetic field disturbance detection, thermal sensors, and RF interference sensors.

3. The system of claim 1 containing at least one of a control board, interface board, Ethernet splitter, power supply and photo switch.

4. The system of claim 1 wherein the camera module further comprises one or more cameras.

5. The system of claim 1 wherein the system further comprises wireless connectivity including Bluetooth®, cellular connection or WiFi®.

6. The system of claim 1 wherein the system is concealed as a planter box or bollard.

7. The system of claim 1 wherein the system is be wrapped with signage or advertisement.

8. A threat detection system comprising:
at least one sensor column having a multi axis magnetic sensor;
a data router; and
a camera module;
wherein a potential threat is detected by the following steps:
analyzing data from the multi axis magnetic sensor;
determining whether the potential threat is similar to a previously known threat;
determining whether a visual image of the area is captured coinciding with the time of the threat detection;
refraining from outputting an alert if the visual image contains a benign object with a similar signature to the determined threat; and
outputting an alert if the visual image contains a positive object match with a similar signature to the determined threat.

9. The system of claim 8 further comprising sensor elements chosen from a list consisting of magnetic sensors, x-ray detectors, electromagnetic pulse, chemical detectors, passive magnetic field disturbance detection, thermal sensors, and RF interference sensors.

10. The system of claim 8 containing at least one of a control board, interface board, Ethernet splitter, power supply and photo switch.

11. The system of claim 8 wherein the camera module further comprises one or more cameras.

12. The system of claim 8 wherein the system further comprises wireless connectivity including Bluetooth®, cellular connection or WiFi®.

13. The system of claim 8 wherein the system concealed as a planter box or bollard.

14. The system of claim 8 wherein the system is wrapped with signage or advertisement.

15. A method of improving the accuracy of a threat detection system, the method comprising:
detecting a potential threat by analyzing data from multi axis sensors;
determining whether the potential threat is similar to a previously known threat;
capturing a visual image of the area coinciding with the time of the threat detection;
providing logic in the threat detector system to refrain from outputting an alert if the visual image contains a benign object with a similar signature to the determined threat; and
providing logic in the threat detector system to output an alert if the visual image contains a positive object match with a similar signature to the determined threat.

16. The method of claim 15 further comprising sensor elements selected from a list consisting of magnetic sensors, x-ray detectors, electromagnetic pulse, chemical detectors, passive magnetic field disturbance detection, thermal sensor, or RF interference sensors.

17. The method of claim 15 containing at least one of a control board, interface board, Ethernet splitter, power supply and photo switch.

18. The method of claim 15 wherein the system further comprises wireless connectivity including Bluetooth®, cellular connection or WiFi®

19. The method of claim 15 wherein the system concealed as a planter box or bollard.

20. The method of claim 15 wherein the system is wrapped with signage or advertisement.
